(19) United States
(12) Patent Application Publication
(10) Pub. No.: US 2008/0050967 A1
(43) Pub. Date: Feb. 28, 2008

(54) CONNECTOR ADAPTERS FOR USE IN USB APPLICATIONS

(76) Inventor: Chris Poulin, Carmel, NY (US)

Correspondence Address: DARBY & DARBY P.C., P.O. BOX 770, Church Street Station, New York, NY, 10008-0770, US

(21) Appl. No.: 11/555,011

(22) Filed: Oct. 31, 2006

Related U.S. Application Data
(60) Provisional application No. 60/823,466, filed on Aug. 24, 2006.

(51) Int. Cl. H01R 13/60

(52) U.S. Cl. 439/567

(57) ABSTRACT

A connector for use in a USB application includes a body having a USB “A” type receptacle at a front section of the body and a terminal block at a rear section of the body. The body has a keystone connector mounting form-factor. Alternatively, body has a first end section and an opposite second end section, wherein the first end section has a USB “A” type receptacle and the second end section has a USB “B” type receptacle.

### CROSS REFERENCE TO RELATED APPLICATION

The present application claims the benefit of U.S. patent application Ser. No. 60/823,466, filed Aug. 24, 2006, which is hereby incorporated by reference in its entirety.

### TECHNICAL FIELD

The present invention relates generally to connector adapters and more particularly, to connector adapters that are particularly suited for use in USB applications and can be used with bulk cables and are provided in the keystone mounting format to permit mounting in existing equipment.

### BACKGROUND

It is often necessary and desirable to electrically connect one component to another component especially in the ever expanding world of computers and electronics, especially in multi-media applications and settings. A number of different interfaces can be used depending upon the precise nature of the setting. USB (Universal Serial Bus) is an electronic transport protocol bus that allows the connection of peripheral devices in computerized systems, such as input devices (mice and keyboards), hard drives, printers, etc., as well as other external devices, such as MP3 players or digital cameras, etc.

Standard USB employs two types of connectors. There is an “A” type connector for the host side, i.e., the computer, and a “B” type connector for the device to be connected to the host. For example, a scanner would have a “B” type connector and a computer that it will be connected to would have an “A” type connector. As a result, the connecting cables typically go from “A” type to “B” type connectors. Both “A” and “B” type connectors have receptacle and plug type connectors which allows mating. An “A” type plug will mate with an “A” type receptacle. Connecting cables usually have plug type connectors.

In other words, “A” connectors head “upstream” toward the computer and “B” connectors head “downstream” and connect to individual devices. By using different connectors on the upstream and downstream, it is impossible to ever get confused. If you connect and USB cable's “B” connector into a device, you know that it will work and similarly, you can plug any “A” connector into any “A” socket and know that it will work.

One popular type of connector and mounting format is known as a “keystone” connector mounting form factor. FIG. 1 shows a typical keystone style connector 10 (e.g., an RJ-45 jack) that employs a stop tab on the bottom and a spring tab on the top to allow the connector 10 to be easily snapped into a pre-determined sized complementary shaped hole, in this case, a rectangular shaped hole. Keystone connectors, like connector 10, are often used for modular connectors, such as RJ-45 and RJ-12 jacks that are typically used for Ethernet network and telephone connections. FIG. 2 shows a conventional wall plate 20 into which a number of connectors 10 can be mounted. Once again, this type of wall plate 20 is constructed to receive keystone style connectors and is thus part of the overall keystone style mounting format.

While USB to terminal block connectors exist, none are constructed in the popular keystone mounting format. As a result, if the end-user wishes to employ bulk cable (pre-made connecting cable) to make their connections, the end-user is required to make the pre-made connector cable lengths available industry-wide fit into their application. This can be a difficult task since the specific application and dimensions and needs of each end-user can vary greatly from one end-user to another. Since the keystone format is widely used and is already present in a number of settings (e.g., pre-installed equipment), if the end-user wishes to employ conventional USB to terminal block connectors, then the user is required to retrofit or remove the existing keystone mounting equipment that is not complementary and compatible and replace it with new equipment. This increases time and costs for the installation.

### SUMMARY

One embodiment of the present invention is directed to a connector for use in a USB application. The connector includes a body having a USB “A” type receptacle at a front section of the body and a terminal block at a rear section of the body. The connector is also configured to have a keystone connector mounting form-factor.

Another embodiment is directed to connector for use in a USB application. The connector includes a body having a first end section and an opposite second end section, wherein the first end section has a USB “A” type receptacle and the second end section has a USB “B” type receptacle. Once again, the connector is configured to have a keystone connector mounting form-factor.

The connectors allow the end-user to employ bulk cable to make their connections instead of trying to make the pre-made connecting cable lengths available industry-wide fit into their applications. In addition, the connectors allow USB signals to pass through keystone type wall plates, panels, and bulkheads, without having to solder.

Other features and advantages of the present invention will be apparent from the following detailed description when read in conjunction with the accompanying drawings.

### BRIEF DESCRIPTION OF THE DRAWING FIGURES

The foregoing and other features of the present invention will be more readily apparent from the following detailed description and drawings figures of illustrative embodiments of the invention in which:

FIG. 1 is a front perspective view of a conventional keystone style connector;

FIG. 2 is a front elevation view of a conventional wall plate into which the connector of FIG. 1 mounts;

FIG. 3 is a front perspective view of a USB A type female to terminal block connector according to a first embodiment of the present invention;

FIG. 4 is a side elevation view of the connector of FIG. 3;

FIG. 5 is a front view of the connector of FIG. 3;

FIG. 6 is a rear view of the connector of FIG. 3;

FIG. 7 is a front perspective view of a USB A type female to B type female according to a second embodiment of the present invention;

FIG. 8 is a side elevation view of the connector of FIG. 7;

FIG. 9 is a front view of the connector of FIG. 7; and

FIG. 10 is a rear view of the connector of FIG. 7.

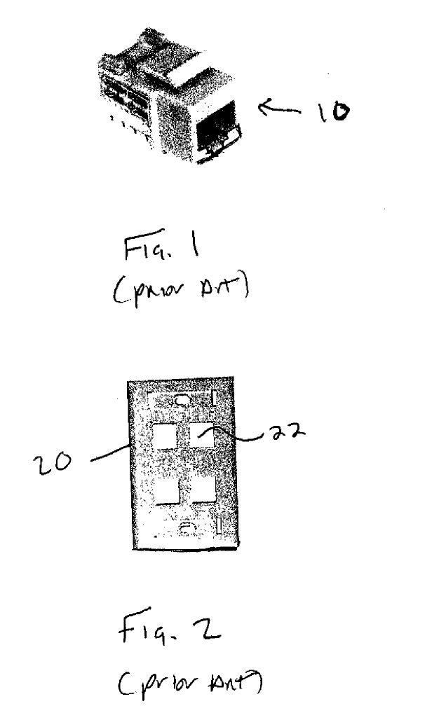

### DETAILED DESCRIPTION OF PREFERRED EMBODIMENTS

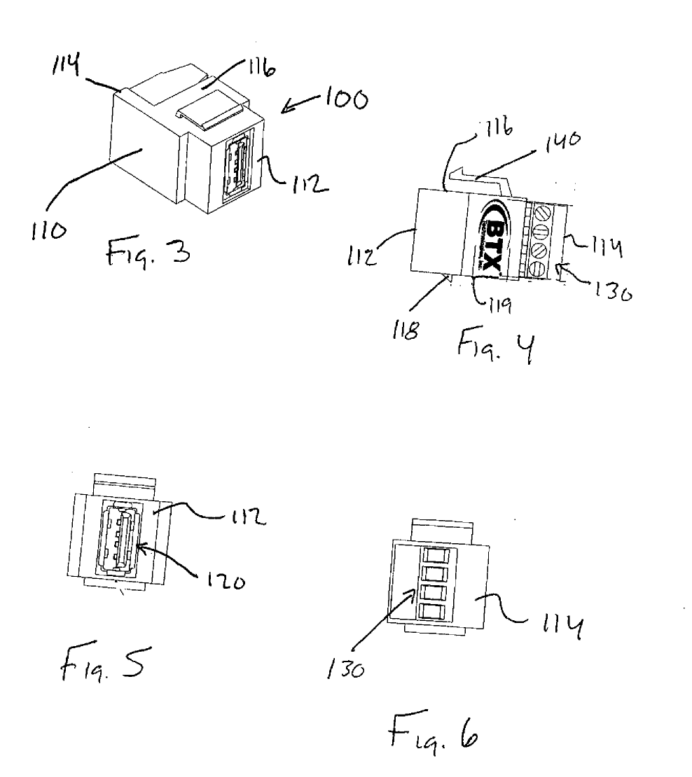

FIGS. 3-6 illustrate a connector adapter 100 according to a first embodiment of the present invention. The connector 100 has a body 110 that has a front section 112 and an opposite rear section 114, as well as a top surface 116. The illustrated connector 100 has an “A” type receptacle 120 (more particularly, a USB “A” type female) formed at the front section 112 for mating with a plug type connector found on the ends of the connecting cable. The connector 100 also has a terminal block 130 at the rear section 114. For example, the terminal block 130 can be similar to a terminal block commercially available from BlockMaster Electronics under the trade name MTS-04008. In other words, the connector 100 is a USB type A female connector in front to a terminal block type connector in the rear.

The components of the connector 100 are placed in a standard keystone type package or mounting form and therefore, the connector employs a stop tab 118 on a bottom surface 119 and a spring tab 140 on the top surface 116 to allow the connector 100 to easily be snapped into a pre-determined sized rectangular hole, such as the hole 22 that is formed as part of the wall plate 20 (FIG. 2).

The connector 100 thus provides easy to terminate terminal block USB connectivity in an easy to mount keystone form-factor. The keystone form-factor allows the use of pre-made panels and plates that are widely available industry wide. Since the keystone type system is widely used, the plates (such as wall plates 20) and panels are typically in use in most facilities and can be employed without further cost to the end-user. As shown in FIG. 2, the wall plate 20 includes four holes or openings 22 that are configured to receive keystone type connectors and therefore, each opening 22 can receive one connector 100 of the present invention. In this manner, USB signals can pass through the wall plate 20 from the host, such as a computer that can be stored at a remote location, to the external device that is connected to the connector 100 via a connecting cable.

It will also be appreciated that the connector 100 allows the end-user to employ bulk cable to make their connections instead of trying to make the pre-made connecting cable lengths available industry-wide fit into their applications.

Accordingly, the connector 100 allows USB signals to pass through wall plates, panels, and bulkheads, without having to solder. It employs the standard USB “A” type receptacle 120 on the front section 112 and the terminal block 130 on the rear section 114. This allows the use of cable at any length desirable instead of using pre-made cables. The terminal block 130 has openings and contacts associated therewith for receiving members, such as wires, etc., that are to be electrically connected to the contacts. The terminal block 130 has a means 131 to securely position and hold the members within the openings of the terminal block 130. In the illustrated embodiment, the means 131 is in the form of fasteners, such as screws, that can be tightened to secure the member within the openings and conversely, loosened to permit removal of the members from the openings.

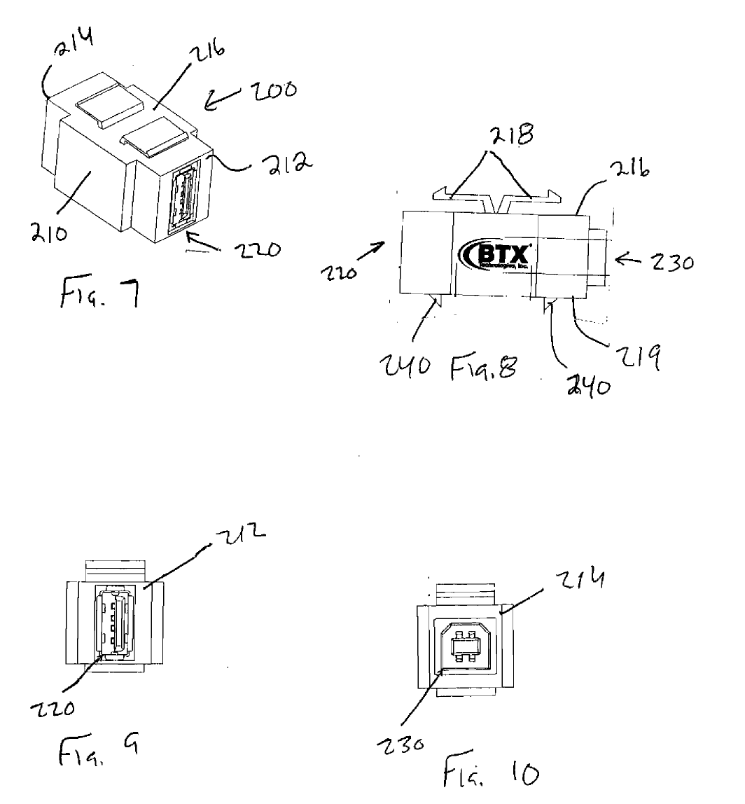

FIGS. 7-10 illustrate a connector adapter 200 according to a second embodiment of the present invention. As with the connector 100, the connector 200 allows USB signals to pass through wall plates, panels, and bulkheads without having to use solder.

The connector 200 has a body 210 that includes a first end section 212, a second section 214, and a top surface 216. The connector 200 has an “A” type receptacle 220 formed at the first end section 212 and a “B” type receptacle 230 formed at the other second side section 214. Similar to the connector 100, the connector 200 is in a standard keystone type packaging allowing it to be used in standard keystone wall plates and panels (FIG. 2). It will also be appreciated that the connector 200 is reversible in that either the A type receptacle or the B type receptacle can be oriented forward depending upon which way the connector 200 is mounted in the plate or panel.

The body 210 includes a pair of spring tabs 218 formed on the top surface 216 to permit mounting of the connector 200 in either direction relative to the wall panel or plate. In addition, the body 210 includes stop tabs 240 on a bottom surface 219 at both the first and second end sections 212, 214 to permit either the A type receptacle 220 or the B type receptacle 230 to face forward through the panel or wall plate, etc. This offers the end-user a great deal of convenience and variability.

It will be appreciated by persons skilled in the art that the present invention is not limited to the embodiments described thus far with reference to the accompanying drawings; rather the present invention is limited only by the following claims.

What is claimed is:

1. A connector for use in a USB application comprising:
a body having a USB “A” type receptacle at a front section of the body and a terminal block at a rear section of the body, wherein the body has a keystone connector mounting form-factor.

2. The connector of claim 1, wherein the body includes a top surface that has a resilient spring tab and a bottom surface that has a stop tab.

3. The connector of claim 1, wherein the “A” type receptacle is configured to receive an “A” type connector that is formed at one end of a USSB cable and the terminal block includes a plurality of openings that have associated contacts to permit an electrical connection with an element received within one opening.

4. The connector of claim 1, wherein the terminal block includes a plurality of openings that have associated contacts to permit an electrical connection with an element received within one opening and a means for securely locking the elements within the openings.

5. The connector of claim 4, wherein the means comprises a plurality of fasteners, each opening having its own associated fastener.

6. A USB connector arrangement comprising:
a keystone type mounting wall plate or panel having one or more openings formed therethrough;
the connector of claim 1 disposed in one opening and mounted to the wall plate or panel in a snap-fit manner, with the USB A type receptacle facing forward through the opening; and
a connecting cable for connecting the terminal block to a host device.

7. The arrangement of claim 6, wherein the host device comprises a computer.

8. The arrangement of claim 6, wherein the body includes a top surface that has a resilient spring tab and a bottom surface that has a stop tab, the spring tab engaging a first element associated with the wall plate or panel and the stop tab engaging a second element associated with the wall plate or panel to provide a snap-fit mount between the body and wall plate or panel.

9. A connector for use in a USB application comprising:
a body having a first end section and an opposite second end section, wherein the first end section has a USB “A” type receptacle and the second end section has a USB “B” type receptacle and the body has a keystone connector mounting form-factor.

10. The connector of claim 9, wherein the body includes a top surface that has a pair of spring tabs, one of which is associated with the first end section and the other is associated with the second end section and a bottom surface that has a pair of stop tabs, one of which is associated with the first end section and the other is associated with the second end section.

11. The connector of claim 10, wherein one spring tab opens in a first direction and the other spring tab opens in an opposite second direction to permit interlocking of the body with a substrate in either a first manner in which the “A” type receptacle faces outward or a second manner in which the “B” type receptacle faces outward.

12. The connector of claim 9, wherein the “A” type receptacle and “B” type receptacle are electrically connected to one another.

13. A USB connector arrangement comprising:
a keystone type mounting wall plate or panel having one or more openings formed therethrough;
the connector of claim 9 disposed in one opening and mounted to the wall plate or panel in a snap-fit manner, with either the USB A type receptacle or the USB B type receptacle facing forward through the opening; and
a connecting cable for connecting the connector to a host device.

14. The arrangement of claim 13, wherein the host device comprises a computer.

15. The arrangement of claim 13, wherein the body includes a top surface that has a pair of spring tabs, one of which is associated with the first end section and the other is associated with the second end section and a bottom surface that has a pair of stop tabs, one of which is associated with the first end section and the other is associated with the second end section, one of the spring tabs engaging a first element associated with the wall plate or panel and the associated stop tab engaging a second element associated with the wall plate or panel to provide a snap-fit mount between the body and wall plate or panel.

16. The arrangement of claim 13, wherein the opening of the wall plate or panel has a rectangular shape and the body has a rectangular shape with a reduced width at each of the first and second end sections.
